(19) United States
(12) Patent Application Publication
(10) Pub. No.: US 2019/0220797 A1
(43) Pub. Date: Jul. 18, 2019

(54) Method for designing a personal or work related project based on a project personality assessment which measures harmony

(71) Applicant: James Bunch, Boulder, CO (US)

(72) Inventor: James Bunch, Boulder, CO (US)

(21) Appl. No.: 15/869,829

(22) Filed: Jan. 12, 2018

(51) Int. Cl. G06Q 10/06

(52) U.S. Cl. CPC G06Q 10/063116; G06Q 10/0635

(57) ABSTRACT

A method for designing a project based on identifying and assessing a person's personality traits (i.e. personality assessment). The personality assessment measures a project participant's personality characteristics which are relevant to project planning. The characteristics which are measured include desirability ratings for emotional risk taking, freedom constraints, complexity, learning, uniqueness and social interaction. Also, the invention includes a method for designing a project based on the project participants need for unity and rhythm.

### CROSS REFERENCE TO RELATED APPLICATIONS

Not Applicable.

### STATEMENT OF FEDERALLY SPONSORED RESEARCH OR DEVELOPMENT

Not Applicable.

### BACKGROUND OF THE INVENTION

Project management is a booming industry. There are numerous software options available to the private individual or business entity. The options provide time management and organization tools that are designed to improve productivity. The tools are useful when it comes to managing and organizing project related tasks. However, the tools are deficient when it comes to improving project harmony. Project harmony is the positive emotions someone feels for a project. Project harmony is important because it affects motivation and enthusiasm. Project participant motivation and enthusiasm are important factors that can determine the success or failure of a project.

Project management needs a method that improves project harmony. A method that improves harmony would require a technique that is tailored to an individual. The technique would need to assess the individual personal characteristic because the factors that affect harmony can be of a personal nature. For example, two people who are given tight deadlines and are required to attend frequent meetings may experience different emotions regarding the deadlines and meetings. One person may dislike the meetings but enjoy the structure from the deadlines. The other person may resent the tight deadlines but enjoy the social interaction from the meetings.

### BRIEF SUMMARY OF THE INVENTION

The invention provides a method which can be used to design a personal or work related project based on the personality traits of each project participant. By focusing on individual personality traits, the invention provides a novel and comprehensive approach to designing a project. Project participants using the invention will be able to improve project harmony because the project design will take into account the project participant's needs, interests and motivations.

The invention involves six steps. The six steps are illustrated in FIG. 1. The first step (110) creates a project personality assessment for each project participant. The assessment identifies personality traits which are relevant to project planning. The second step (120) involves creating one or more preliminary designs based on the personality assessment(s). The third step reviews the design(s) (130) to see if the design(s) matches the needs, interests and motivations that were determined from the personality assessment(s). The fourth step is called unity. Unity checks to see if the design(s) indirectly improves the dominant needs that were identified in the personality assessment(s) (140). The fifth step is called rhythm. Rhythm checks the design(s) itinerary and activities to determine if there is adequate rhythm (150). Adequate rhythm is determined by each project participant. The sixth step involves choosing the best design (160). The best design will be used for the project.

### BRIEF DESCRIPTION OF THE SEVERAL VIEWS OF THE DRAWING

FIG. 1 illustrates an overview of the invention. The invention is comprised of six steps which are described by boxes and triangles in FIG. 1.

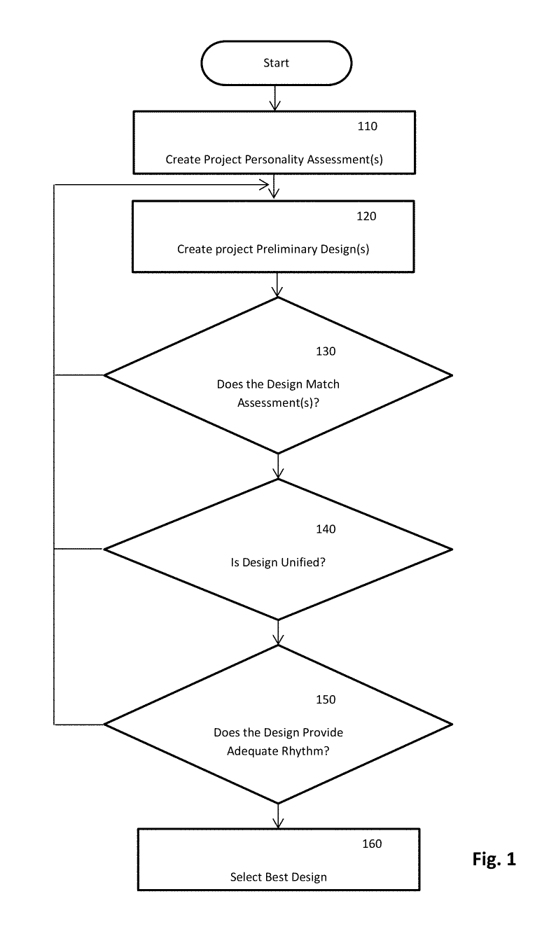

FIG. 2 illustrates three design principles which are used to create visual bars. Visual bars are used to define personality traits. The three design principles are dominance, opposition and balance.

FIG. 3 illustrates a visual bar for emotional safety and emotional risk. FIG. 3 can be used to define the personality trait for emotional risk taking desirability.

FIG. 4 illustrates a visual bar for freedom and freedom constraints. FIG. 4 can be used to define the personality trait for freedom constraints desirability.

FIG. 5 illustrates a visual bar for Simplicity and Complexity. FIG. 5 can be used to define the personality trait for complexity desirability.

FIG. 6 illustrates a visual bar for knowledge/skills and learning. FIG. 6 can be used to define the personality trait for learning desirability.

FIG. 7 illustrates a visual bar for familiarity and uniqueness. FIG. 7 can be used to define the personality trait for uniqueness desirability.

FIG. 8 illustrates a visual bar for privacy and social interaction. FIG. 8 can be used to define the personality trait for social interaction desirability.

FIG. 9 illustrates visual bars for comparing a preliminary design with a personality assessment. FIG. 9 can be used to determine if a preliminary design matches a personality assessment.

### DETAILED DESCRIPTION OF THE INVENTION

The invention involves six steps (see ‘Brief Summary of the Invention’ for an overview of the six steps). The first step (110) is the most important step. This step creates the project personality assessment. The project personality assessment is based on three design principles. The purpose of each design principle is to maximize harmony for the project participant. Harmony is defined as a pleasing sensation which is the result of combining project variables. There are twelve project variables which are used in the project personality assessment. The reason harmony is important in step one is because harmony can affect motivation and enthusiasm. Consequently, the purpose of the project personality assessment is to define personality traits which are relevant to maximizing harmony during a project.

The first design principle which is used in the project personality assessment is called dominance. Dominance is when a person experiences harmony because an instinctual need has been satisfied. Examples of instinctual needs are emotional safety and the need for freedom. When someone pursues a project, the person should satisfy their instinctual needs to experience harmony. Fulfilling an instinctual need is considered a dominant need. The following list describes six dominant needs which are used in the project personality assessment:
1. Emotional safety is a dominant need. Emotional safety refers to your need to successfully complete an important project.
2. Freedom is a dominant need. Freedom refers to your need to be free and independent.
3. Simplicity is a dominant need. Simplicity refers to your need to easily comprehend your environment. Simplicity involves being able to relax because you are able to understand your surroundings.
4. Knowledge and skills prerequisites is a dominant need. Knowledge and skills prerequisites refers to a person's need for having sufficient knowledge and skills for a given task, event or situation.
5. Familiarity with your surroundings is a dominant need. Familiarity refers to your need to be familiar with your surroundings.
6. Privacy is a dominant need. Privacy refers to your need for privacy for yourself and your group.

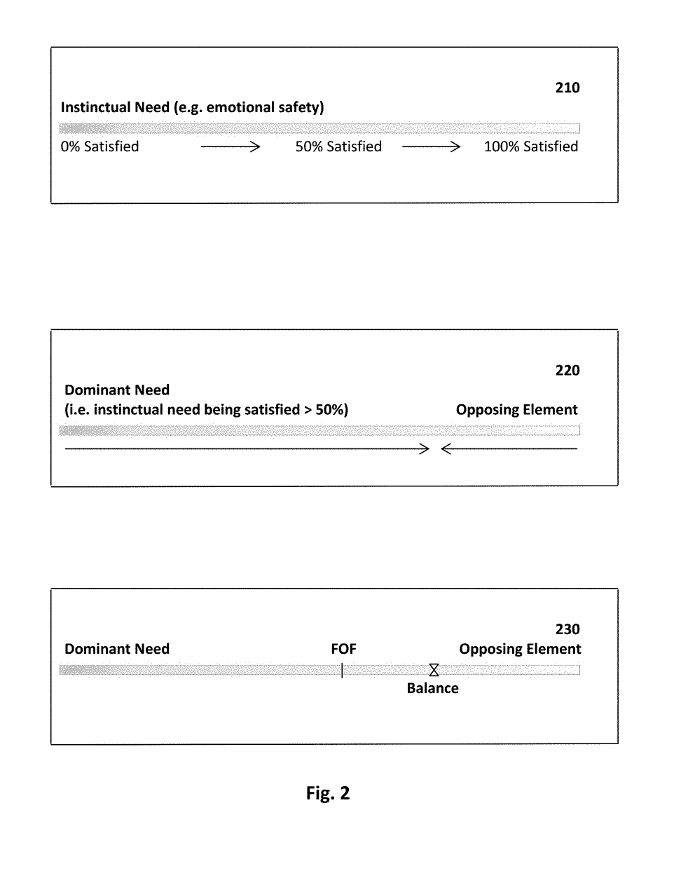

The visual bar (210) in FIG. 2 represents the satisfaction level for an instinctual need. Moving from left to right, the scale measures being 0-100% satisfied. An instinctual need is considered dominant when the satisfaction level exceeds the 50% mark on the visual bar. For example, someone tasked with completing an easy project may feel satisfied they will complete the project on time. In this situation, the instinctual need for emotional safety would be dominant because the project participant considers the probability of completing the project is greater than 50%.

Opposition is when you add a project variable which opposes a dominant need. This application refers to an opposing project variable as an opposing element. When you add an opposing element to a dominant need, you can increase harmony beyond what is achievable from dominance alone. For example, you can improve harmony by adding emotional risk to emotional safety. However, you can only add a certain amount of emotional risk to improve harmony. If you add too much emotional risk then you can create disharmony. The correct amount to add is entirely dependent on each project participant. Also, another term for adding an opposing element to a dominant need is called “adding a challenging situation or event to the project plan”.

The following list describes six opposing elements which are used in the project personality assessment:
1. Emotional risk is an opposing element. Emotional risk opposes emotional safety. For example, you can add emotional risk to a project plan by adding a task which may be difficult to complete.
2. Freedom constraint is an opposing element. Freedom constraint opposes freedom. For example, you can add a freedom constraint to a project plan by adding a deadline or including a task which has an obstacle.
3. Complexity is an opposing element. Complexity opposes simplicity. For example, you can add complexity to a project plan by adding a task which requires mental concentration.
4. Learning is an opposing element. Learning opposes your current knowledge and skills. For example, you can add learning to a project plan by adding a task which requires learning in order to complete the task.
5. Uniqueness is an opposing element. Uniqueness opposes familiarity. For example, you can add uniqueness to a project plan by adding a task which is unique.
6. Social interaction is an opposing element. Social interaction opposes privacy. For example, you can add social interaction to a project plan by adding a task which requires significant social interaction with strangers.

The visual bar (220) in FIG. 2 has been modified to include an opposing element. An opposing element adversely affects an instinctual need. If you use emotional safety as an example, an opposing element (i.e. emotional risk) can result in risk to a person's instinctual need for emotional safety.

Balance is the third design principle which is used in the project personality assessment. Balance is when a person maximizes harmony by adding the correct amount of opposing element to a dominant need. The correct balance is dependent on each project participant's personality trait. If a person adds too much opposing element, they can invoke a Fight-or-Flight response (FOF). An FOF is when an opposing element approaches dominance and the dominant need starts to lose its dominance. For example, if a person increases emotional risk to the point it becomes dominant, the project participant will fight to regain dominance for emotional safety or they will flee the situation (e.g. quit their job) thereby eliminating emotional risk. The personality assessment discourages FOF situations because FOF situations are potentially harmful and can decrease harmony. The following visual bar (230) has been modified to include a balance symbol (i.e. carrot symbol) and a FOF indicator.

There are six visual bars in the project personality assessment. The visual bars can be represented by a computer program (e.g. slider bar display tool) or the visual bars can be represented in a paper document. Each visual bar is used to document a specific personality trait. The six personality traits that are documented by the project personality assessment are: emotional risk taking desirability, freedom constraint desirability, complexity desirability, learning desirability, uniqueness desirability, and social interaction desirability.

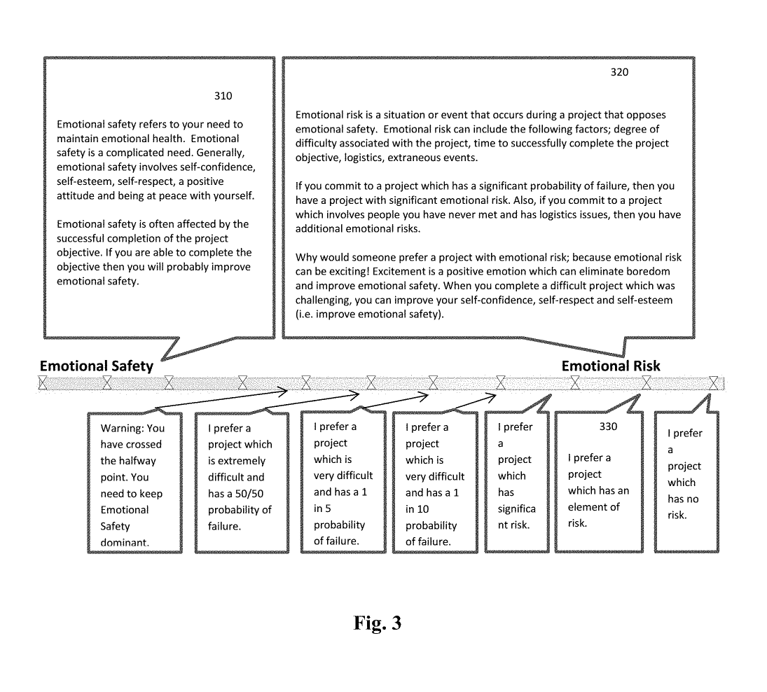

The visual bar in FIG. 3 illustrates the personality traits for emotional safety (i.e. dominant need) and emotional risk (i.e. opposing element). Emotional safety is a dominant need because everyone has an instinctual need for remaining emotionally safe. Emotional risk can be added to emotional safety to create a sense of excitement (i.e. harmony). The amount of risk that is added to create excitement depends on the person. Some people enjoy risk and some people hate risk. One of the purposes of the invention is to determine which opposing elements are preferred by project participants and how much they prefer. The process of selecting an opposing element and how much opposing element a project participant prefers is how the invention determines a personality trait.

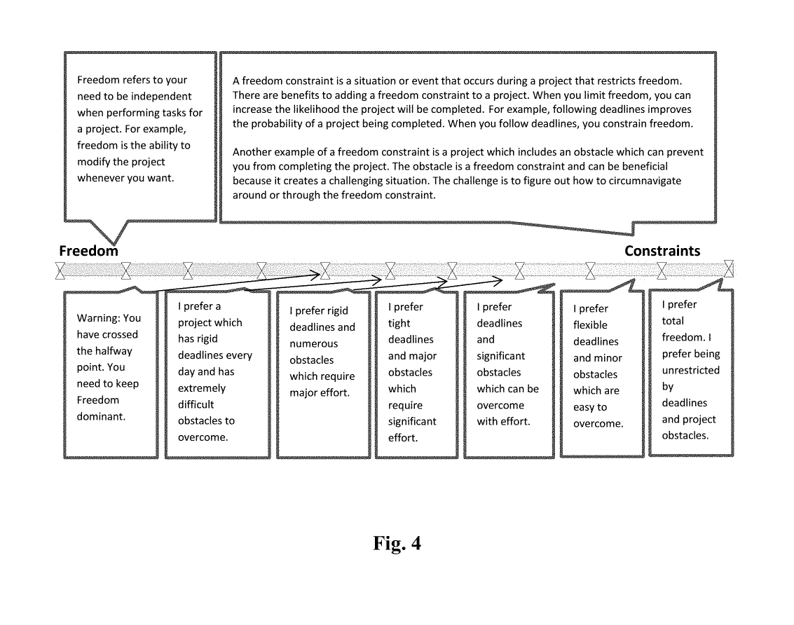

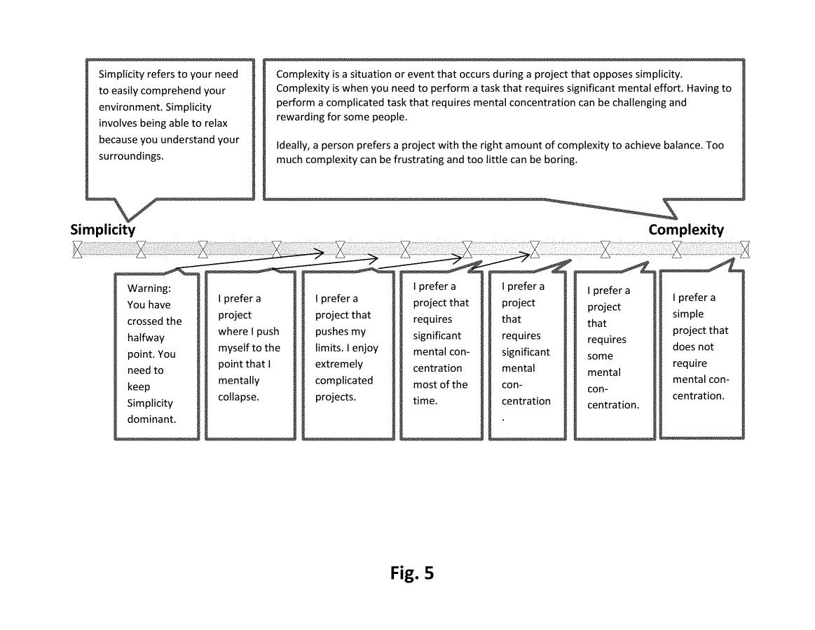

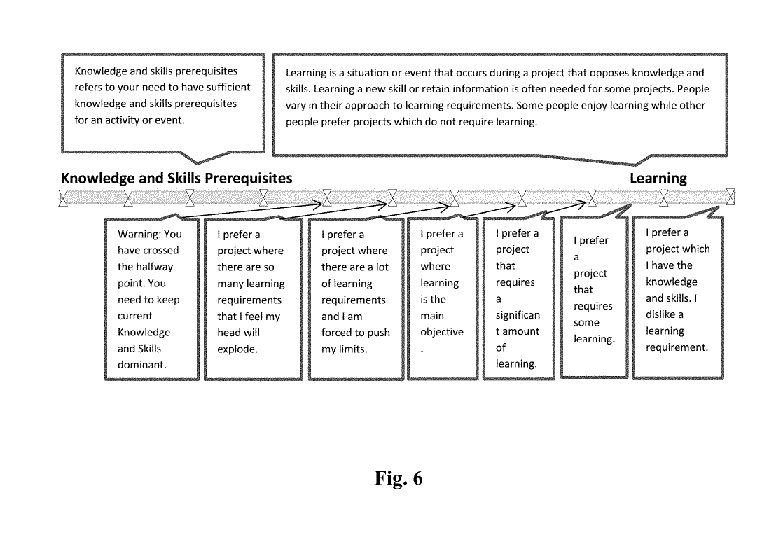

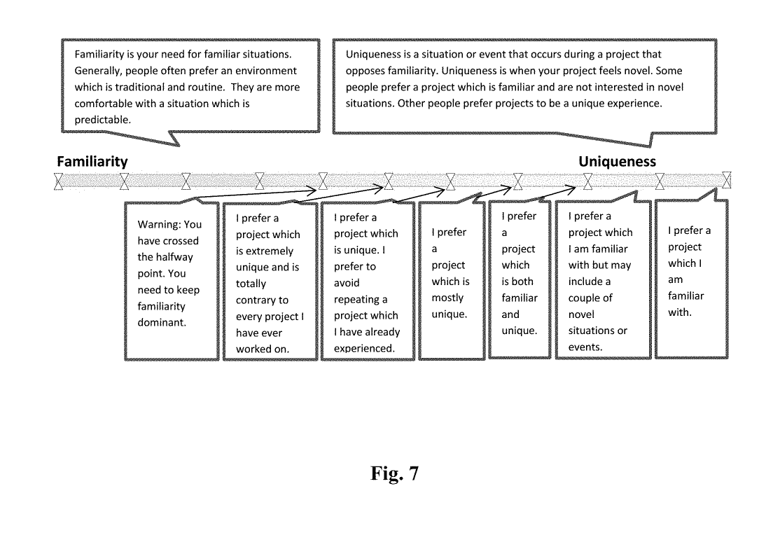

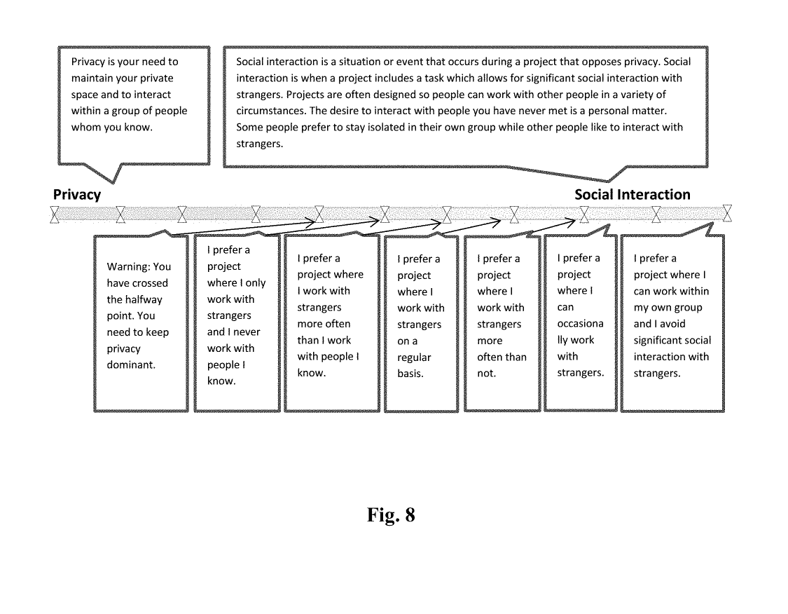

The box (310) in FIG. 3 provides a definition for emotional safety. The box (320) provides a definition for emotional risk. Each box below the visual bar represents a definition for balance. The project participant can select one box below the visual bar. The box they select is a personality trait. The project participant has the option of overwriting the text in the box they select. For example, if the project participant selects box (330) they have the option of overwriting the text “I prefer a project which has an element of risk”, and entering whatever information they prefer. FIGS. 4, 5, 6, 7 and 8 provide five other examples of visual bars that are used in the project personality assessment.

Step 2 (120) can be initiated after each project participant completes a project personality assessment. Step 2 involves creating one or more preliminary designs based on the personality assessment(s). The preliminary design(s) that are created need to take into account the information that was filled out in the project personality assessment(s). For example, if all the assessments include a strong desirability for learning then the preliminary design should include an activity that involves learning.

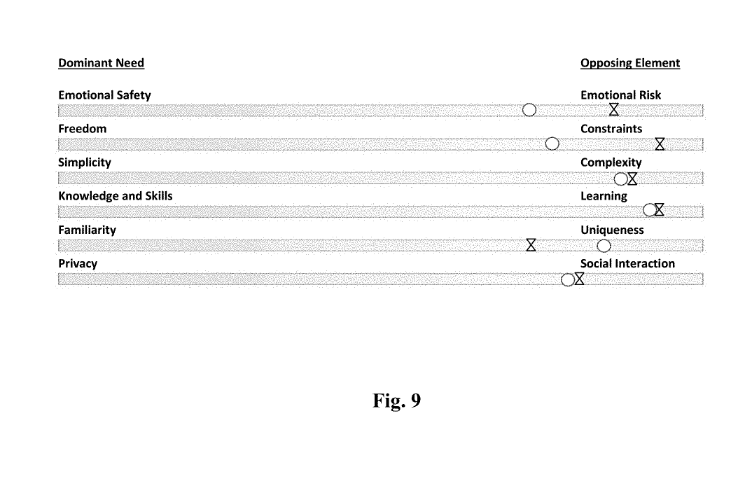

Step 3 (130) can be initiated after all the preliminary designs have been completed. Step 3 involves reviewing each preliminary design to see if the design matches the project personality assessment(s). If a preliminary design does not match the project personality assessment(s) then the preliminary design may need to be modified. FIG. 9 demonstrates the matching process when comparing a preliminary design with a personality assessment. The circle represents the preliminary design value and the triangles are the personality assessment value. Generally, if the circle is significantly to the left of the triangles then this could indicate anxiety and frustration for the preliminary design. If the circle is significantly to the right then this could indicate boredom for the preliminary design.

Step 4 (140) can be initiated after all the preliminary design(s) have been reviewed. Step 4 determines if a preliminary design involves unity. Unity is when an activity in a preliminary design includes an opposing element that improves a dissimilar dominant need. The following is an example of unity:
Learning a new work-related skill involves unity. When you learn (opposing element) a new skill, you can improve your dissimilar dominant need for freedom and your dissimilar dominant need for emotional safety. In other words, learning a new skill can allow you to; complete the project, improve your job skills so you can demand more money, improve your marketability, have more freedom when working on future projects.

Unity can be measured for an activity in a preliminary design by listing all the opposing elements for the activity and then listing all the dissimilar dominant needs that are improved for each of the opposing elements. Each preliminary design is reviewed for unity. If a preliminary design does not involve unity then the preliminary design may need to be modified.

Step 5 (150) can be initiated after all the preliminary design(s) have been reviewed for unity. Step 5 determines if a preliminary design has adequate rhythm. Adequate rhythm is determined by the repetitive movements of a task and by the overall pace of the schedule in a preliminary design. The invention determines if a preliminary design has adequate rhythm by asking each project participant to fill out a questionnaire. The questionnaire provides information, instructions and a list of questions on how to improve rhythm when creating a preliminary design. If a preliminary design does not have adequate rhythm according to the project participant(s), then the preliminary design may need to be modified.

Step 6 (160) can be initiated after all the preliminary design(s) have been reviewed for rhythm. Step 6 involves reviewing the preliminary design(s) and selecting the best design. The review process includes comparing the preliminary design(s) to the project personality assessment(s) and reviewing the designs for unity and adequate rhythm. The best preliminary design will be used for the project.

What is claimed:

1. A method for creating project preliminary design(s) based on project personality assessment(s), wherein said method comprises the steps of:
a. Determining emotional risk taking desirability for project participant(s);
b. Determining freedom constraint desirability for project participant(s);
c. Determining complexity desirability for project participant(s);
d. Determining learning desirability for project participant(s);
e. Determining uniqueness desirability for project participant(s);
f. Determining social interaction desirability for project participant(s);
g. Creating preliminary design(s) based on desirability ratings for project participant(s);
h. Modifying preliminary design(s) as needed when preliminary design(s) do not match the personality assessment(s);

2. The method of claim 1 wherein the step of determining emotional risk taking desirability for project participant(s) comprises the steps of:
a. Provide a definition for emotional safety;
b. Provide a definition for emotional risk;
c. Determine the balance (i.e. emotional risk taking desirability) between emotional safety and emotional risk;

3. The method of claim 1 wherein the step of determining freedom constraint desirability for project participant(s) comprises the steps of:
a. Provide a definition for freedom;
b. Provide a definition for freedom constraint;
c. Determine the balance (i.e. freedom constraint desirability) between freedom and freedom constraint;

4. The method of claim 1 wherein the step of determining complexity desirability for project participant(s) comprises the steps of:
a. Provide a definition for simplicity;
b. Provide a definition for complexity;
c. Determine the balance (i.e. complexity desirability) between simplicity and complexity;

5. The method of claim 1 wherein the step of determining learning desirability for project participant(s) comprises the steps of:
a. Provide a definition for knowledge/skills;
b. Provide a definition for learning;
c. Determine the balance (i.e. learning desirability) between knowledge/skills and learning;

6. The method of claim 1 wherein the step of determining uniqueness desirability for project participant(s) comprises the steps of:
a. Provide a definition for familiarity;
b. Provide a definition for uniqueness;
c. Determine the balance (i.e. uniqueness desirability) between familiarity and uniqueness;

7. The method of claim 1 wherein the step of determining social interaction desirability for project participant(s) comprises the steps of:
a. Provide a definition for privacy;
b. Provide a definition for social interaction;
c. Determine the balance (i.e. social interaction desirability) between privacy and social interaction;

8. The method of claim 1 wherein the step of creating preliminary design(s) based on desirability ratings for project participant(s) comprises the steps of:
a. Determine activities from desirability information;
b. Determine tasks from desirability information;
c. Creating preliminary designs based on activities and tasks;

9. The method of claim 1 wherein the step of modifying preliminary design(s) as needed when preliminary design(s) do not match the personality assessment(s) comprises the steps of:
a. Compare the preliminary design(s) to the project personality assessment(s);
b. Modify the preliminary design(s) when significant discrepancies are observed between the preliminary designs(s) and the personality assessment(s);

10. A method for modifying a preliminary design based on how unified the design is, wherein said method comprises the steps of:
a. Determine the opposing elements for design activities and tasks;
b. Determine the dissimilar dominant needs that are improved by the opposing elements;
c. Modify the preliminary design(s) when there is insufficient unity;

11. A method for modifying a preliminary design based on adequate rhythm, wherein said method comprises the steps of:
a. Determine whether the design includes repetitive activities and tasks;
b. Determine whether the design schedule has good overall pace;
c. Modify the preliminary design(s) when there is insufficient rhythm;

12. A method for selecting the best preliminary design, wherein said method comprises the steps of:
a. Compare the preliminary designs to the project personality assessment(s);
b. Review the preliminary designs for unity;
c. Review the preliminary designs for rhythm;
d. Select the best preliminary design based on the comparisons and reviews;
